(19) United States
(12) Patent Application Publication
(10) Pub. No.: US 2024/0059389 A1
(43) Pub. Date: Feb. 22, 2024

(54) OIL-WATER SEPARATION UNIT AND DISCHARGE MONITORING SYSTEM FOR SMALL SHIP

(71) Applicant: TAEJIN ENGINEERING CO., LTD., Yeongam-gun (KR)

(72) Inventor: Tae Gon YEO, Jindo-gun (KR)

(21) Appl. No.: 18/270,534

(22) PCT Filed: Dec. 3, 2021
(86) PCT No.: PCT/KR2021/018235

§ 371 Date: Jun. 30, 2023

(30) Foreign Application Priority Data
Dec. 31, 2020 (KR) 10-2020-0188873

(51) Int. Cl. B63J 4/00; B01D 17/02

(52) U.S. Cl. CPC B63J 4/00; B01D 17/0202; B01D 17/0217

(57) ABSTRACT

The present invention relates to an oil-water separator and discharge monitoring system for a ship. The system includes a power supply unit that is provided in the ship and supplies electric power; an oil-water separation unit that receives power from the power supply unit and separates oil and water from each other; and a monitoring module for tracking, in real time, operating states of the power supply unit and the oil-water separation unit, and including a control unit, wherein the oil-water separation unit includes an oil-water tank, a connection pipe connected to the oil-water tank, an oil-water separation pump installed on the connection pipe, and an oil-water separation filter assembly for separating oil and water supplied from the oil-water separation pump, and wherein the oil-water separation filter assembly includes a housing having an inlet portion and a discharge portion for oil and water, a guide member for guiding oil and water flowing into the housing through an inlet port in a spiral direction to form a swirling flow, a first oil filter for primarily separating oil and water flowing in the spiral direction by the guide member by means of centrifugal force, an adsorption material arranged on an upper side of the first oil filter to absorb separated oil thereon, and a second oil filter installed inside the housing so as to secondarily separate the oil and water filtered through the first oil filter.

### TECHNICAL FIELD

The present invention relates to a monitoring system, and more specifically, to an oil-water separation unit and a discharge monitoring system for a small ship for tracking, in real time, operating states of an oil-water separation unit and a generator.

### BACKGROUND ART

In general, a ship is installed with an oil-water separator for separating oil from oil-mixed seawater. The importance of the oil-water separators is highlighted due to frequent accidents of oil spills from ships into the sea.

However, in many cases, the oil-water separators are not installed on small ships. Therefore, bilge water, i.e., a mixture of oil and seawater is first collected and then treated separately.

The oil-water separator for a ship used in ships of 100 tons or more is a model of medium-capacity or higher, and uses a parallel plate method and a gravity separation or floating separation method so as to increase the processing capacity.

Korean Patent Application Publication No. 2013-0019238 discloses an oil detection and separation apparatus for a ship, and Korean Patent Application Publication No. 2021-0079513 discloses a double filter for ship repair.

Korean Patent No. 10-1380646 discloses an oil-water separation system and an oil-water separation method. The disclosed oil-water separation system includes a slop tank for storing a mixture and performing a first oil-water separation process for the stored mixture, and a control unit that is connected to the slop tank by a first pipe so that a primary filtrate filtered through the first oil-water separation process is introduced, and determines whether to discharge overboard the primary filtrate and selectively discharges the filtrate overboard.

Since the oil-water separation system has a structure in which oil-water separation is performed in multiple stages by gravity, there is a problem in that a relatively large amount of time is required for oil-water separation.

### DETAILED DESCRIPTION OF THE INVENTION

### Technical Problem

The present invention has been made in view of the above circumstances, and an object thereof is to provide an oil-water separation unit and discharge monitoring system for a small ship capable of being miniaturized to be able to be applied to a small ship, effectively performing oil-water separation by power generated using flow of seawater even while a ship is sailing or stopped, and monitoring the oil-water separation.

Another object of the present invention is to provide an oil-water separation unit and discharge monitoring system for a small ship capable of improving efficiency of oil-water separation since oil-water separation can be performed using centrifugal separation by swirling of the oil-water and a filter.

### Technical Solution

In order to achieve the above objects, an oil-water separation unit and discharge monitoring system for a ship according to an embodiment of the present invention includes:
a power supply unit provided in the ship and configured to supply electric power;
an oil-water separation unit configured to receive power from the power supply unit and to separate oil and water from each other; and
a monitoring module configured to track, in real time, operating states of the power supply unit and the oil-water separation unit,
wherein the oil-water separation unit includes an oil-water tank, a connection pipe connected to the oil-water tank, an oil-water separation pump installed on the connection pipe, and an oil-water separation filter assembly for separating oil and water supplied from the oil-water separation pump, and
wherein the oil-water separation filter assembly includes a housing having an inlet portion and a discharge portion for oil and water, a guide member configured to guide oil and water flowing into the housing through an inlet port in a spiral direction to form a swirling flow, a first oil filter configured to primarily separate oil and water flowing in the spiral direction by the guide member by means of centrifugal force, an adsorption material arranged on an upper side of the first oil filter to absorb separated oil thereon, and a second oil filter installed inside the housing so as to secondarily separate the oil and water filtered through the first oil filter.

In the present invention, the oil-water separation unit includes a controller including an oil-water detector installed on the connection pipe on an outlet side of the oil-water separation filter assembly and configured to measure a concentration of oil and water, and if the concentration is equal to or higher than a reference value, to discharge oil and water through the connection pipe, and if the concentration is below the reference value, to block the connection pipe and to switch a flow path to a front stage of the oil-water separation pump via a return pipe connecting the connection pipe on the outlet side of the oil-water separation filter assembly and the connection pipe on an inlet side of the oil-water separation pump.

The guide member includes a pair of guides each having a semi-circular shape along a circumferential direction around the inlet portion, arranged to face each other and spaced from each other by a predetermined interval.

The housing includes a blocking wall formed in a circumferential direction along an outer edge of the guide member and protruding at a predetermined height, and the blocking wall is configured to prevent oil and water forming the swirling flow from flowing out to the second oil filter on a lower side before reaching the first oil filter.

The power supply unit includes a generator arranged in the ship, a housing rotatably supported on a rotary shaft of the generator and positioned outside a hull, a propeller shaft installed on the housing, a propeller configured to generate rotational force by an ocean flow being installed on the propeller shaft, and a power transmission unit installed in the housing and configured to transmit rotational force of the propeller shaft to the rotary shaft of the generator.

### Advantageous Effects

In the oil-water separation unit and discharge monitoring system for a ship according to the present invention, the filtered oil and water is detected and it is accordingly ensured that the oil and water can be discharged below the reference concentration, thereby enabling automatic control. In addition, the operating information such as a discharge concentration and an amount of discharge of separated seawater can be checked in real time. Therefore, reliability of the oil-water separation unit regarding the oil-water separation can be improved.

In addition, the present invention separates the oil and water using the filter and the centrifugal separation by the swirling flow of oil and water and can be thus miniaturized so that it can be applied to a small ship, and can effectively perform oil-water separation with power generated using the flow of seawater even while the ship is sailing or stopped.

### BRIEF DESCRIPTION OF DRAWINGS

FIG. 1 is a view schematically showing an oil-water separator and monitoring module for a ship according to an embodiment of the present invention.

FIG. 2 is a cross-sectional view of an oil-water separation filter assembly.

FIG. 3 is a cross-sectional view taken along a line A-A shown in FIG. 2.

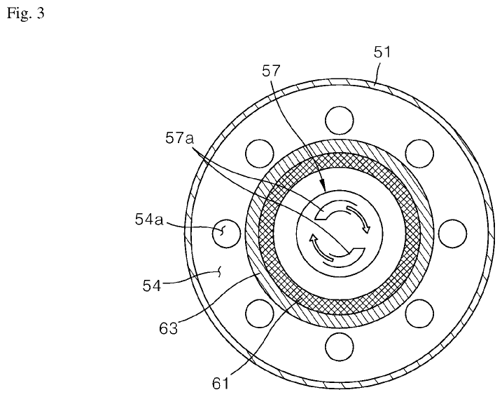

FIG. 4 is an enlarged cross-sectional view showing a power generation unit shown in FIG. 1.

### BEST MODE

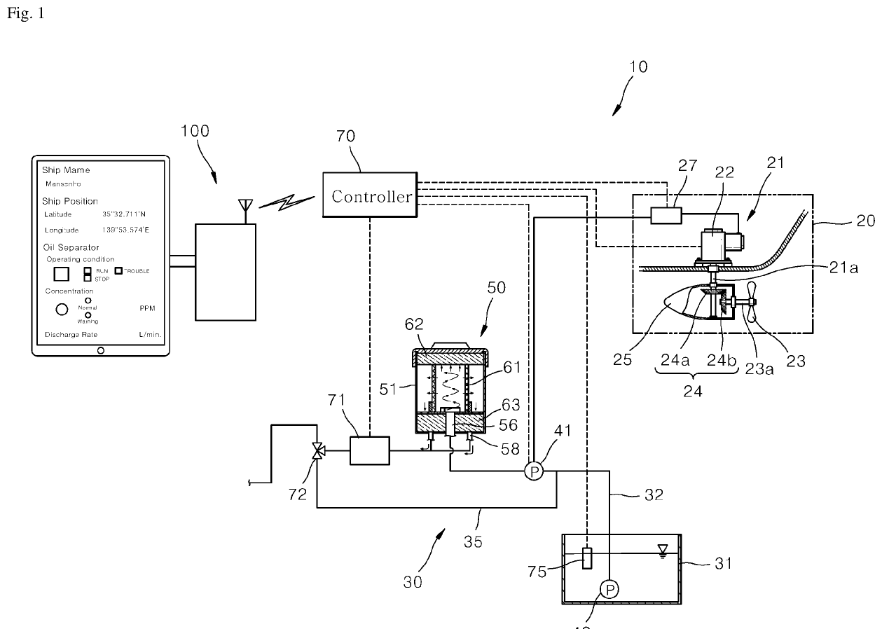

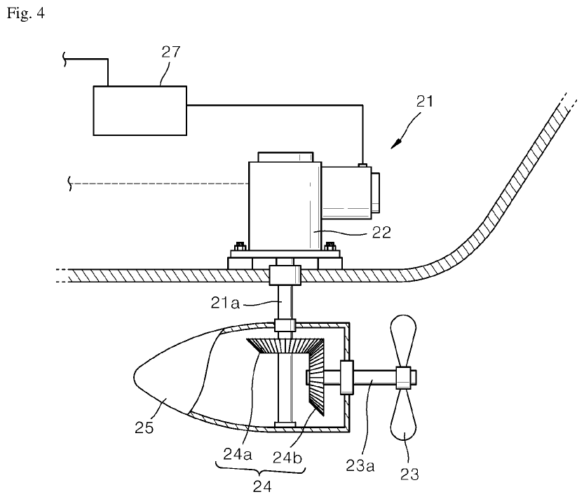

An embodiment of an oil-water separation unit and discharge monitoring system for a small ship according to the present invention is shown in FIGS. 1 and 4.

Referring to the drawings, an oil-water separation unit and discharge monitoring system 10 for a small ship according to the present invention includes a power supply unit 20 that is provided in a ship and supplies electric power, and an oil-water separation unit 30 that receives power from the power supply unit 20 and separates oil and water from each other. The system also includes a monitoring module 100 that tracks, in real time, operating states of the power supply unit 20 and the oil-water separation unit 30.

The oil-water separation unit and discharge monitoring system for a small ship according to the present invention configured as described above will be described in more detail for each component.

The oil-water separation unit 30 includes an oil-water tank 31 and a connection pipe 32 connected to the oil-water tank 31 to discharge seawater from which oil and water have been separated from each other. In addition, the oil-water separation unit includes, on a pipe line of the connection pipe 32, an oil-water separation pump 41 for pumping oil and water in which oil and seawater for separation are mixed, and an oil-water separation filter assembly 50 for separating oil and water supplied from the oil-water separation pump 41. The oil-water separation pump 41 may be connected to a main pump 42 installed in the oil-water tank 31, and may directly pump oil and water for separation from the oil-water tank 31.

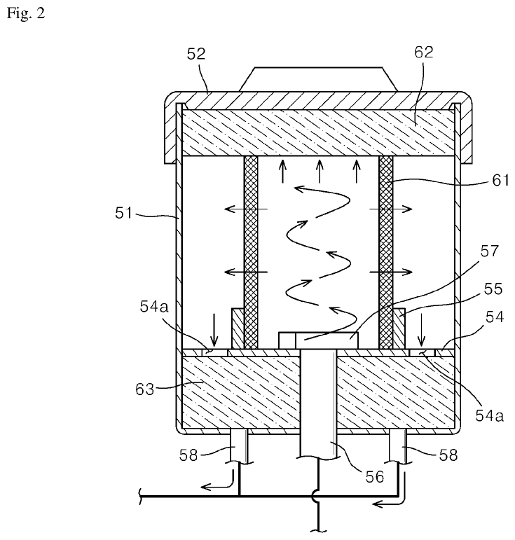

As shown in FIGS. 1 and 2, the oil-water separation filter assembly 50 is installed on the connection pipe line to separate oil and water, and includes a housing 51 in which a separation partition wall 54 for dividing an internal space into upper and lower sides is formed. A blocking wall 55 having a predetermined height is formed in a circumferential direction on an upper side of the separation partition wall 54. The blocking wall 55 prevents a swirling flow of oil and water, which is generated by a guide member described later, from flowing out to a second oil filter on a lower side before reaching a first oil filter.

The separation partition wall 54 is connected to an inlet portion 56 into which oil and water for separation is introduced from the outside, and the outer partition wall partitioned by the blocking wall 55, i.e., the separation partition wall 54 between the blocking wall 55 and the housing 51 is formed with discharge holes 54a. The discharge holes 54a communicate the upper space and the lower space of the housing 51 partitioned by the separation partition wall 54. In addition, an outlet portion 58 that is connected to the lower space partitioned by the separation partition wall 54 is formed on a lower side of the housing 51.

A swirling flow generating member 57 for swirling oil and water introduced from the inlet portion 56 is installed on the upper surface side of the separation partition wall 54. The swirling flow generating member 57 includes a pair of guides 57a each having a semi-circular shape along a circumferential direction around the inlet portion 56, arranged to face each other and spaced from each other by a predetermined interval. The swirling flow generating member 57 is not limited to the above-described embodiment, and may have any configuration that can swirl oil and water introduced through the inlet portion 56. For example, the swirling flow generating member may be configured by a branch pipe connected to the inlet portion 56 and bent in opposite directions.

In the upper space of the housing 51 partitioned by the separation partition wall 54, a first oil filter 61 coupled to or supported by the blocking wall is installed, and an oil adsorption member 62 is installed on an upper side of the first oil filter 61. In the lower space partitioned by the separation partition wall 54, a second oil filter 63 is installed.

Meanwhile, a cap 52 that is coupled and separated to open and close the inner space of the housing 51 is installed on an upper side of the housing 51.

In addition, the oil-water separation unit 30 includes a controller 70 including an oil-water detector 71 that is installed on the connection pipe on an outlet side of the oil-water separation filter assembly 50, measures a concentration of oil and water, and if the concentration is equal to or higher than a reference value, discharges oil and water through the connection pipe, and if the concentration is below the reference value, blocks the connection pipe and switches a flow path to a front stage of the oil-water separation pump 41 via a return pipe 35 connecting the connection pipe on the outlet side of the oil-water separation filter assembly 50 and the connection pipe on the inlet side of the oil-water separation pump. To this end, a three-way valve 72 is installed at a connection part between the connection pipe 32 and the return pipe 35, and a water level sensor 75 is installed in the oil-water tank 31. The three-way valve 72 is controlled by the controller 70, and the controller 70 detects a water level in the oil-water tank 31 by the water level sensor 75 to drive the oil-water separation pump.

The power supply unit 20 includes a power generation unit 21 that is mounted on a ship and generates electric power using a moving ocean current, and an energy storage unit 27 for storing electric power generated by the power generation unit 21. However, the power supply unit is not limited thereto, and may further include a solar power generation module that is installed on the ship. The energy storage unit 27 may be configured by a secondary battery capable of charging and discharging, and the energy storage unit 27 supplies power to drive the oil-water separation pump 41.

The power generation unit 21 of the power supply unit 20 includes a generator 22 installed on the ship, and a casing 25 that is rotatably supported by a rotary shaft 21a of the generator 22 and is positioned to be submerged in seawater outside the hull. Here, the casing 25 may be supported on the hull by a separate support shaft, instead of being directly installed on the rotary shaft 21a, and a universal joint may be installed between the support shaft and the rotary shaft.

A propeller shaft 23a is rotatably installed on the casing 25, a propeller 23 for generating rotational force by the ocean current is installed on the propeller shaft 23a, and a power transmission unit 24 for transmitting the rotational force of the propeller 23 to the rotary shaft 21a of the generator 22 is installed in the casing 25. Although not shown in the drawing, a separate follower wing capable of following a flow direction of the ocean current may be installed on the casing 25.

The power transmission unit 24 includes a driven gear 24a installed in the casing 25 and connected to the rotary shaft 21a of the generator 22, and a drive gear 24b that engages with the driven gear 24a and has the propeller shaft 23a installed at the center thereof.

The monitoring module 100 includes the controller 70, can receive and monitor, in real time, operating states of the power supply unit 20 including the power generation unit 21, which is controlled by the controller 70, and the oil-water separation unit 30, and transmits the monitoring information and the position information of the ship obtained through GPS so that they can be simultaneously monitored by related organizations at remote locations.

In the oil-water separation unit and discharge monitoring system for a small ship according to the present invention configured as described above, the electric power is supplied to the controller 70 and the oil-water separation pump 41 of the oil-water separation unit 70 by the energy stored in the energy storage unit 27 of the power supply unit 20 installed on the ship.

As for the power generation by the power generation unit 21 of the power supply unit 20, since the casing 25 that is rotatably installed on the rotary shaft 21a of the generator 22 installed on the ship and has the propeller 23 installed thereon is submerged in the sea, the propeller 23 rotates while following the flow of the ocean current. The propeller shaft 23a on which the propeller 23 is installed rotates, so that the rotary shaft 21a of the generator 22 is rotated by the power transmission unit 24 installed inside the casing 25, thereby generating electric power. The electric power generated in this way is stored in the energy storage unit 27.

On the other hand, the oil-water separation unit 30 receives electric power from the energy storage unit 27, and when the water level sensor 75 detects the oil and water stored in the oil-water tank 31 as having a set water level or higher, the controller 70 drives the oil-water separation pump 41.

The driving of the oil/water separation pump 41 causes the oil and water stored in the oil-water tank 31 to be supplied to the inlet portion 56 of the oil-water separation filter assembly 50 through the connection pipe 32. The oil and water supplied to the inlet portion 56 generates a spiral swirling flow by the swirling flow generating unit 57 to promote separation of oil and seawater. Such a swirling flow is filtered through the first oil filter 61, and the oil raised by the swirling flow of oil and water is adsorbed by the oil adsorption member 62. The oil and water having passed through the first oil filter 61 passes through the second oil filter 63 positioned in the lower space of the housing 51 through the discharge holes 54a of the separation partition wall 54, so that oil is separated.

The water separated from the oil and water as described above is discharged through the discharge portion 58 along the connection pipe 32. During this process, the separated state of oil is detected by the oil-water detector 71 installed on the connection pipe 32 adjacent to the discharge portion 58, and if the detected value is equal to or higher than the reference value, the oil and water is discharged through the connection pipe, and if the detected value is below the reference value, the connection pipe is blocked using the three-way valve 73, and the oil and water are returned to the inlet side connection pipe of the oil-water separation pump through the return pipe.

As described above, the information that is controlled by the controller 70 is transmitted to the monitoring module 100 and is transmitted to the management organizations by the monitoring module 100, thereby enabling monitoring even at a remote location.

As described above, the oil-water separator and discharge monitoring system for a ship according to the present invention can generate electric power using the ocean current or sunlight, drive the oil-water separation unit using the electric power, swirl the mixture of oil and water and separate oil in multiple stages. Therefore, the reliability and separation efficiency regarding the oil-water separation can be increased.

While the present invention has been described with reference to the embodiment shown in the drawings, the embodiment is only exemplary, and one skilled in the art will understand that various modifications and equivalent embodiments can be made from the embodiment. Therefore, the true technical protection scope of the present invention should be determined by the technical spirit of the attached claims.

1. An oil-water separation unit and discharge monitoring system for a ship, comprising: a power supply unit provided in the ship and configured to supply electric power;
an oil-water separation unit configured to receive power from the power supply unit and to separate oil and water from each other; and
a monitoring module configured to track, in real time, operating states of the power supply unit and the oil-water separation unit,
wherein the oil-water separation unit comprises an oil-water tank, a connection pipe connected to the oil-water tank, an oil-water separation pump installed on the connection pipe, and an oil-water separation filter assembly for separating oil and water supplied from the oil-water separation pump, and
wherein the oil-water separation filter assembly comprises a housing having an inlet portion and a discharge portion for oil and water, a guide member configured to guide oil and water flowing into the housing through an inlet portion in a spiral direction to form a swirling flow, a first oil filter configured to primarily separate oil and water flowing in the spiral direction by the guide member by means of centrifugal force, an adsorption material arranged on an upper side of the first oil filter to absorb separated oil thereon, and a second oil filter installed inside the housing so as to secondarily separate the oil and water filtered through the first oil filter.

2. The oil-water separation unit and discharge monitoring system for a ship according to claim 1,
wherein the oil-water separation unit comprises a controller comprising an oil-water detector installed on the connection pipe on an outlet side of the oil-water separation filter assembly and configured to measure a concentration of oil and water, and if the concentration is equal to or higher than a reference value, to discharge oil and water through the connection pipe, and if the concentration is below the reference value, to block the connection pipe and to switch a flow path to a front stage of the oil-water separation pump via a return pipe connecting the connection pipe on the outlet side of the oil-water separation filter assembly and the connection pipe on the inlet side of the oil-water separation pump.

3. The oil-water separation unit and discharge monitoring system for a ship according to claim 1,
wherein the guide member comprises a pair of guides each having a semi-circular shape along a circumferential direction around the inlet portion, arranged to face each other and spaced from each other by a predetermined interval.

4. The oil-water separation unit and discharge monitoring system for a ship according to claim 3,
further comprising a blocking wall formed in a circumferential direction along an outer edge of the guide member and protruding at a predetermined height,
wherein the blocking wall is configured to prevent oil and water forming the swirling flow from flowing out to the second oil filter on a lower side before reaching the first oil filter.

5. The oil-water separation unit and discharge monitoring system for a ship according to claim 1,
wherein the power supply unit comprises a generator arranged in the ship, a housing rotatably supported on a rotary shaft of the generator and positioned outside a hull, a propeller shaft installed on the housing, a propeller configured to generate rotational force by an ocean flow being installed on the propeller shaft, and a power transmission unit installed in the housing and configured to transmit rotational force of the propeller shaft to the rotary shaft of the generator.

6. The oil-water separation unit and discharge monitoring system for a ship according to claim 1,
wherein the power transmission unit comprises a driven gear installed in the housing and connected to the rotary shaft of the generator, and a drive gear configured to engage with the driven gear and having the propeller shaft installed at a center thereof.
